(19) United States
(12) Patent Application Publication
(10) Pub. No.: US 2009/0256123 A1
(43) Pub. Date: Oct. 15, 2009

(54) Dual center-mount and rear axle stand for motorbikes and method of use

(76) Inventor: Darby Bernard Heck, Portland, OR (US)

Correspondence Address: MARK S. HUBERT P.C., 516 SE MORRISON- SUITE 1200, PORTLAND, OR, 97214, US

(21) Appl. No.: 12/082,500

(22) Filed: Apr. 11, 2008

(51) Int. Cl. B62H 3/00

(52) U.S. Cl. 254/131

(57) ABSTRACT

A compact and sturdy stationary stand for a motorbike which is capable of being used as both a rear axle stand and a center-mount stand. The stand can be inserted into the rear axle and the motorbike can simply be rocked back onto the stand to lock the bike in an upright position. The motorbike remains in a fixed upright position, and the chain can be removed or lubricated with ease. When used as a center-mount stand, the motorbike simply rests or balances on the stand, and the motorbike can be positioned such that one wheel is always on the ground, allowing the other wheel (elevated) to be worked on or removed.

### BACKGROUND OF THE INVENTION

The present invention relates to a motorbike stand assembly, and more particularly, to a motocross motorbike rear axle and downpipe stationary stand assembly.

Some of the most popular motorbike stands on the market for maintenance are box stands. Generally, the prior art of center maintenance stands resemble just structurally reinforced cubes that the motorbike's frame's downpipes rest on. Box stands or any center mount stand have a distinct advantage over other models in that both of the motorbike's wheels can be raised off the ground, allowing work on one or both wheels, while allowing the drive train to remain rotationally free for maintenance. The downside to box stands, is that the motorbike must be lifted onto the stand. Since most motorbikes exceed 250 pounds, this balancing and lifting requires two people.

There are stands on the market that have addressed this lifting issue, but these stands require levers that often malfunction and these stands are quite expensive. Additionally, there are motorbike stands that function like wheel chock restraint systems. The disadvantages of these stands are that they have numerous, adjustable parts that are prone to failure, and maintenance on the motorbike is an issue, since one wheel is restrained and the other wheel is on the ground.

The present invention is a geometrically configured steel bar assembly that can be placed adjacent the frame's downtubes or into the rear wheel axle where the motorbike can easily be urged into a stationary position of central or rear suspension. There is no balance point and the motorbike is stable from tipping from all directions. To move the motorbike in any direction from the stand requires the bike to be physically lifted upward. The stand also has a multi directional activation feature that allows the motorbike to be placed on the stand by a forward or rearward rocking and lifting motion, and allows the motorbike to be removed from the stand by another forward or rearward rocking and lifting motion (when in the rear axle mount position) regardless of which direction the prior motion was. Conventional motorbike stands must be engaged in one directional motion only (usually rearward) and the disengagement motion is in the reverse direction.

Henceforth, a dual center-mount and rear axle stand, would fulfill the long felt need in the motocross motorbike industry. This new invention utilizes and combines both known and new technologies in a unique and novel configuration to overcome the aforementioned problems of the prior art.

### SUMMARY OF THE INVENTION

The general purpose of the present invention, which will be described subsequently in greater detail, is to provide a motocross motorbike stand capable of supporting the motorbike via the rear axle or the bottom location of the downtubes such that one of the motorbike's wheels is off the ground.

Another objective of the present invention is to provide an easy method for a lone person to arrange the support of a motorbike in a upright position without having to lift the motorbike.

Yet another objective would be to provide a stand to display an identifying placard for the motorbike rider.

The present invention has the advantages mentioned heretofore and many novel features that result in a new motocross stand which is not anticipated, rendered obvious, suggested, or even implied by any of the prior art, either alone or in any combination thereof.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is an isometric view of preferred embodiment motorbike stand;

FIG. 2 is a side view of a motocross motorbike with the stand inserted in the rear axle before the motorbike has been rocked back onto the stand;

FIG. 3 is a side view of a motocross motorbike with the stand mounted in the rear axle;

FIG. 4 is a side view of a motocross motorbike center-mounted on the stand;

FIG. 5 is a rear view of only the rear wheel assembly of a motorbike with the stand mounted in the rear axle;

FIG. 6 is a front view of the alternate embodiment of the stand;

FIG. 7A is a top view of the preferred embodiment;

FIG. 7B is a front view of the preferred embodiment;

FIG. 7C is a side view of the preferred embodiment;

FIG. 7D is a back view of the preferred embodiment;

FIG. 8 is an isometric view of the sleeve.

### DETAILED DESCRIPTION

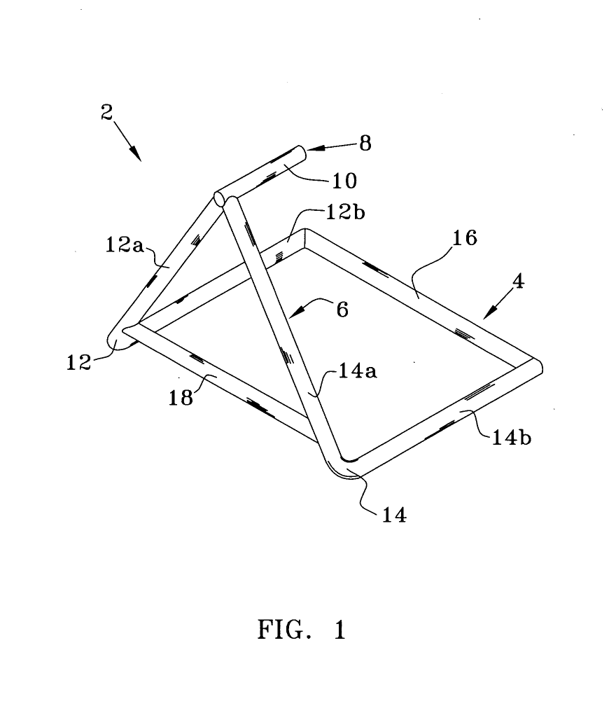

The preferred embodiment of the present invention is illustrated in FIG. 1. Support means 2 (stand) is shown, comprising a generally planar bottom support portion 4, an upraised middle portion 6 integrally connected to the bottom support portion 4, and a generally horizontal upper portion 8, integrally connected to said middle portion 6. The upper portion 8 comprises a single rearward extending linear peg 10.

The planar bottom support portion 4 and the upraised middle portion 6 are constructed from a first bent metal bar 12 and a substantially similar second bent metal bar 14. First bent metal bar 12 has an upper portion 12a and a lower portion 12b. Similarly, second metal bar 14 has an upper portion 14a and a lower portion 14b. The upper portion 12a of the first bar 12 converges with the upper portion 14a of second metal bar 14 at a juncture where the linear peg 10 is attached and extends therefrom so as to form upraised middle portion 6.

The lower portion 12b of bent metal bar 12 and the lower portion 14b of bent metal bar 14 are integrally connected along the planar bottom support portion 4 via cross-bar 16. For additional support a second cross-bar 18 integrally connects the upper portion 12a of the first bent metal bar 12 and the upper portion 14a of the second bent metal bar 14, forming a generally enclosed triangular region between the second cross-bar 18, upper portion 12a and upper portion 14a.

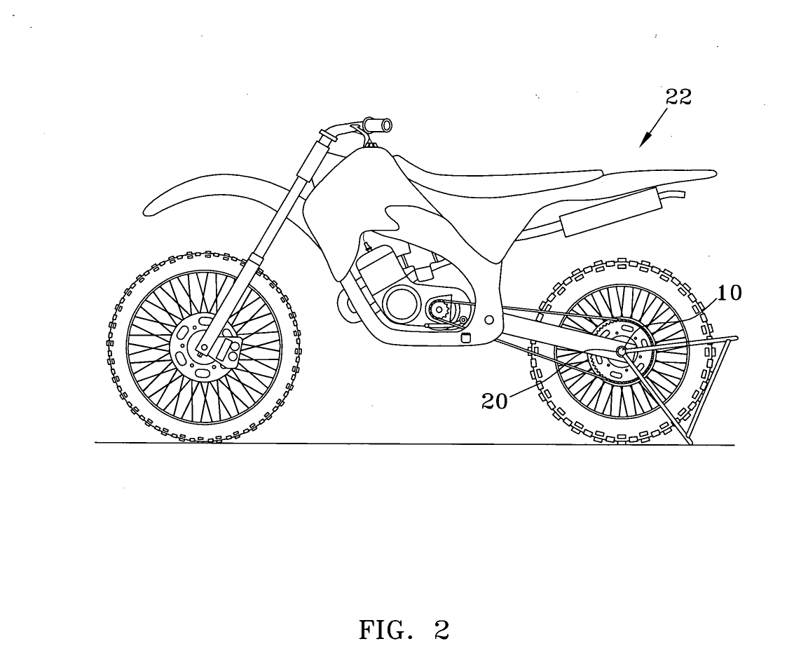

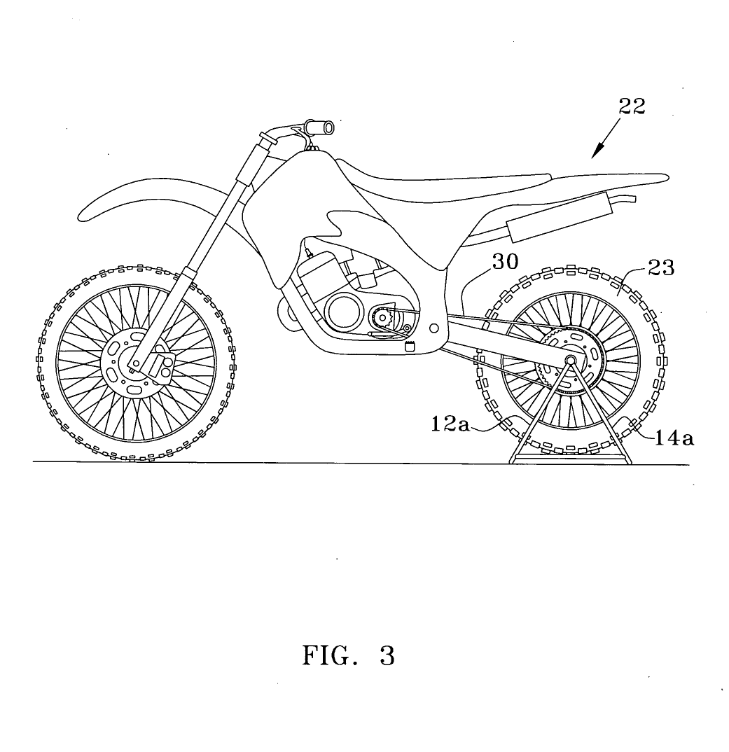

FIG. 2 illustrates how the present invention is positioned when about to be used as a rear axle mount for a motorbike. The linear peg 10 of stand 2 is angularly inserted into the hollow recess of the rear axle 20 of motorbike 22, such that only the lower portion 12b of the first bent metal bar 12 is touching the ground (not visible in FIG. 1). With this positioning an individual can simply roll the motorbike backwards (that is in the direction of the stand 2) to mount the motorbike 22 on stand 2 as seen in FIG. 3. Note, that this stand also has a multi directional activation feature that allows the motorbike to be placed on the stand by a forward or rearward rocking and lifting motion, (depending on which side of the rear tire the stand is positioned when engaged in the rear axle) and allows the motorbike to be removed from the stand by another forward or rearward rocking and lifting motion regardless of which direction the prior motion was. Conventional motorbike stands must be engaged in one directional motion only (usually rearward) and the disengagement motion is in the reverse direction.

In this process of mounting motorbike 22 in the rear axle position on stand 2, lower portion 12b (or 14b) is placed on the ground while the linear peg 10 is engaged in the rear axle recess 20. As the motorbike 22 is rolled backwards (or forwards depending upon the placement of the support means) all the weight normally on the rear wheel 23 is transferred to one of the bent metal bars (12 or 14), thereby increasing that bar's friction with the ground surface and preventing any unwanted sliding of the stand 2 along the ground surface. The friction generated is large enough to allow the forward or rearward push of the motorbike 22 to vertically raise the motorbike 22 onto the locked “secured” rear axle position. The kinetic energy developed in rolling the motorbike backwards is enough to raise the rear wheel off of the ground as the stand 2 pivots about lower portion 12b until lower portion 14b comes to rest on the ground. In this manner a single person may easily develop the kinetic energy to raise the motorbike on the stand 2 without the strenuous effort that lifting the motorbike would require.

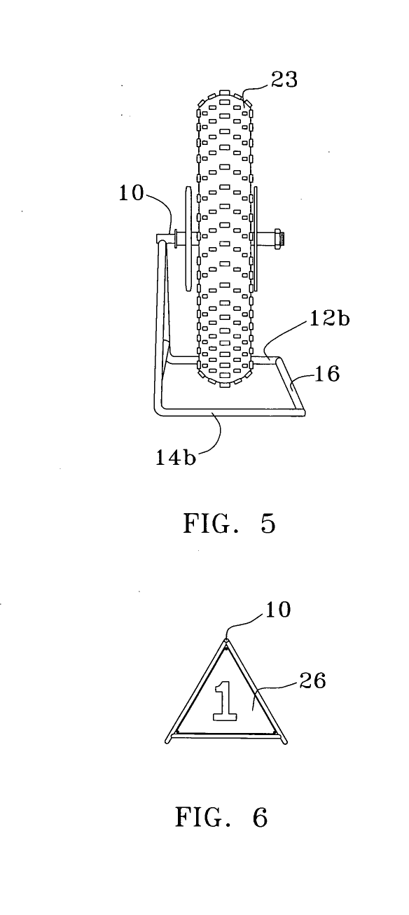

Using stand 2 as a rear axle mount allows the motorbike 22 to remain in the upright position, positions the rear wheel 23 off of the ground and gives the rider full access to the chain 30 (See FIG. 5) as well as the ability to rotate the chain 30 and attenuated gearing. It is to be noted that this design allows for the unidirectional mounting and dismounting of the motorbike 22 on and off the support means. The motorbike may be lifted and pushed forward to raise it in the real axle stand mode, and it can be pushed forward again to lower it out of the real axle stand mode. Similarly, this can be accomplished in the rear direction, depending upon which side of the rear axle the support means is placed on.

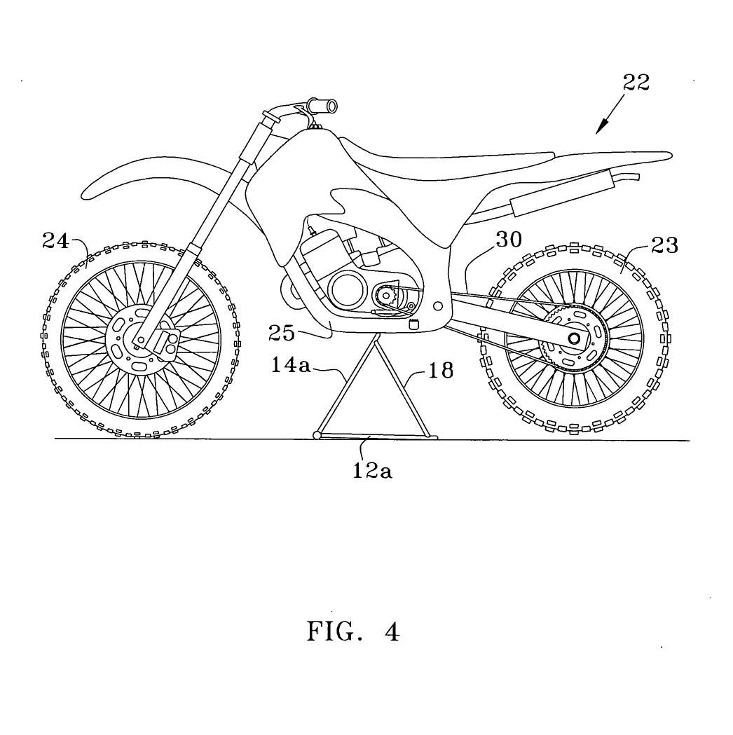

FIG. 4 illustrates how stand 2 can also be used as a center-mounted stand. To use stand 2 as a center-mount stand the down tubes of the frame 25 of motorbike 22 simply rest on the lower portion 12b of first bent metal bar 12 or the lower portion 14b or second bent metal bar 14 (not visible in FIG. 3). That is, in order to employ stand 2 as a center-mount stand the orientation of stand 2 must change by 90 degrees from how it is utilized as a rear axle stand; the linear peg 10 must reside on the ground for two reasons. First, the linear peg is too short to span the downtubes in all motorbikes, and second because it lacks support at both of it ends, whereas lower portion 12b (or lower portion 14b) is supported at both of its ends. One individual can also mount motorbike 22 in the center-mount by placing stand 22 between the front wheel 24, and the frame 25, and lifting the rear wheel 23 off of the ground, slightly moving the motorbike 22 forward (that is in the direction of the stand 2) until the stand 2 is caught under the frame 25 of the motorbike 22. If the motorbike is positioned such that it's center of mass is located approximately above whichever lower portion the downtubes are residing upon, shifting the motorbike ever so slightly to the rear or front changes which wheel touches the ground. Thus, using stand 2 as a center-mount stand allows the user to position the motorbike so that either wheel is off the ground and allows for access to the engine and drive train and also allows removal of whichever wheel is positioned off of the ground.

FIG. 6 illustrates an alternate embodiment in which the generally triangular region between the second cross-bar 18, the upper portion of first bent metal bar 12a, the upper portion of the second bent metal bar 14a, and the linear peg 10 has a generally planar placard 26 mechanically affixed within said area. This allows the rider to place his or her riding number or sponsorship advertisements on stand 2.

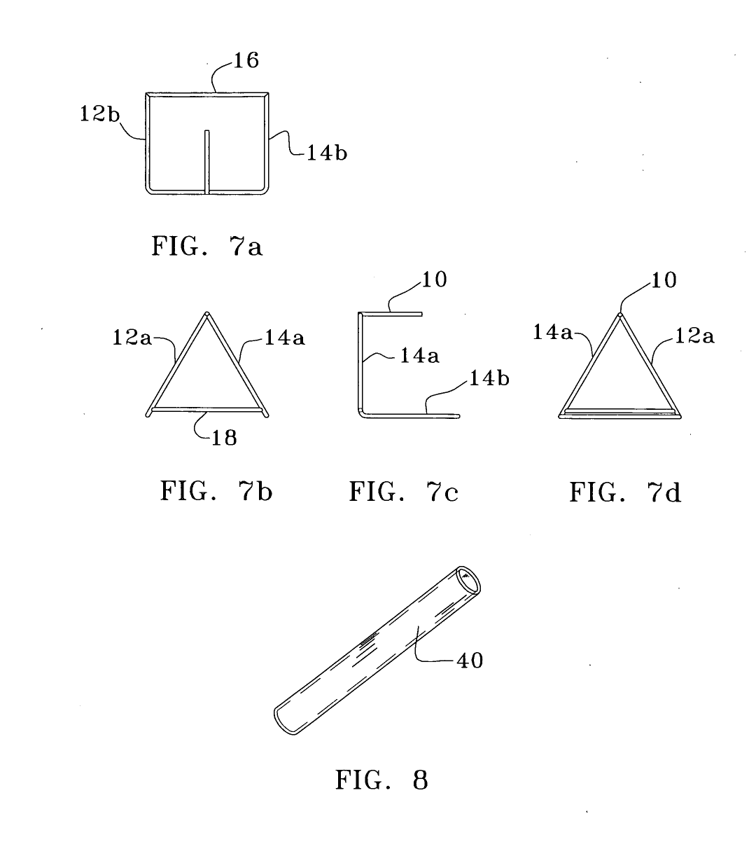

FIGS. 7A-7D illustrate the various views; top, front, side, and back, respectively of the preferred embodiment.

FIG. 8 illustrates a hollow cylindrical sleeve 40 that is slid over linear peg 10 so as to increase the diameter. There is a small but suitable difference between the outer diameter of peg 10 and the inner diameter of sleeve 40 so as to allow a slidable frictional engagement between these parts. This enables the stand 2 to be used with motorbikes having differing diameters on their rear axle.

In the preferred embodiment the material that comprises the stand will be a solid metal or steel bar that is welded at both ends of the first cross-bar 16; both ends of the second cross-bar 18; and at the juncture formed from the convergence of the first bent metal bar 12, the second bent metal bar 14, and the linear peg 10. However, it is known that with proper bending or extrusion techniques the stand 2 can be made from only two pieces; second crossbar 18; and a consolidated peg 10, upper portion 12b, lower portion 12a, first crossbar 16, lower portion 14a and upper portion 14b.

It is to be noted that when motorbike 22 is mounted on stand 2, in either the rear axle mount position or the center-mount position, the motorbike 2 cannot tip over in the forward, rear, left side or right side directions without an applied force that vertically raises the bike. Thus to tip the motorbike over, and excessive force must be applied.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed.

1. A free standing, hi-directional operating motorbike support means capable of supporting an upright motorbike from a rear axle or centrally from the motorbike's downtubes comprising:
a generally C shaped, three sided, support base formed from at least one cylindrical base member, wherein all three sides of said C shaped base reside coplanar,
a vertical, enclosed triangular side formed from a first, a second and a third cylindrical side members, said first and said second side member of said triangular side are connected at a distal end to said support base, and
a linear member that is dimensionally sized for insertion into the rear axle of the motorbike and which extends normally from said triangular side at a junction of the proximate ends of said first and said second side members so as to reside parallel to said support base.

2. The motorbike support means of claim 1 wherein said support base is formed from three cylindrical base members.

3. The motorbike support means of claim 2 wherein two of said side members are connected at a distal end to two of said support base members.

4. The motorbike support means of claim 3 further comprising:
a generally planar placard;
at least one attachment member affixed to said side; and
at least one attachment means,
wherein said placard is constrained therein said enclosed triangular side by at least one attachment means connecting said placard to said attachment member.

5. The motorbike support means of claim 4 wherein said placard is triangular, and the number of said attachment members and said attachment means are each three, and said each attachment member is located adjacent to an interior corner of said side.

6. The motorbike support means of claim 5 further comprising a cylindrical tube having an inside diameter and an outside diameter wherein said inside diameter is sized for frictional engagement over said linear member and said outer diameter is sized for engagement in a motorcycle's rear axle.

7. A dual function motorbike rear axle stand and motorbike center stand comprising:
a unidirectional mounting and dismounting support means for stabilizing said motorbike in an upright position, said means further comprising;
a generally planar, three-sided support portion, a vertical portion connected to said support portion, and a linear peg extending from said vertical portion, wherein said linear peg is sized for insertion into the rear axle of a dirt bike.

8. The dual function motorbike rear axle stand and motorbike center stand of claim 7, wherein said support portion comprises a pair of substantially similar support members, each having a distal end and a proximate end, where said support members are held in a generally parallel configuration by a first cross-bar connected between said distal ends; and wherein said linear peg extends towards said first cross-bar.

9. The dual function motorbike rear axle stand and motorbike center stand of claim 8, wherein said vertical portion comprises a pair of upwardly converging arms connected by a second cross-bar, wherein said arms converge at said linear peg.

10. The dual function motorbike rear axle stand and motorbike center stand of claim 9, wherein a planar placard is mechanically affixed to said vertical portion in an area bounded between said converging arms and said second cross-bar.

11. The dual function motorbike rear axle stand and motorbike center stand of claim 10 further comprising a tubular sleeve frictionally engaged about said linear peg.
